(19) United States
(12) Patent Application Publication
(10) Pub. No.: US 2006/0147345 A1
(43) Pub. Date: Jul. 6, 2006

(54) Taste-sensing mixture and a taste sensor and a taste-sensing system using the same

(76) Inventors: Horn Haw Chen, Hsinchu City (TW); Ren Jang Wu, Hsinchu City (TW); Hung Wei Chen, Hsinchu City (TW); Chuen Yuan Liu, Hsinchu City (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/090,220

(22) Filed: Mar. 28, 2005

(30) Foreign Application Priority Data
Jan. 5, 2005 (TW) 094100244

(51) Int. Cl. G01N 27/02

(52) U.S. Cl. 422/82.02

(57) ABSTRACT

The present invention discloses a taste-sensing mixture, a taste sensor and a taste-sensing system using the same, which measures the conductivity of a solution and analyzes the measuring result by the principle component analysis to differentiate the taste of the solution. The taste-sensing mixture comprises a carrier and a dispersant dispersed in the carrier. Preferably, the carrier is selected from the group consisting of conductive polymer, salt compound and alkene polymer, while the dispersant is selected from the group consisting of alcohol and gel. The alkene polymer is selected from the group consisting of polyvinyl alcohol, polyethylene oxide and polystyrene, the alcohol is selected from the group consisting of glycerol, methanol and ethanol, the conductive polymer can be polypyrrole or polyaniline, the salt compound can be sodium chloride or sodium potassium, and the gel can be agar.

### BACKGROUND OF THE INVENTION

(A) Field of the Invention

The present invention relates to a taste-sensing mixture and a taste sensor and a taste-sensing system using the same, and more particularly, to a taste-sensing mixture and a taste sensor and a taste-sensing system using the same, which differentiates different tastes by measuring the conductivity of a solution under test and analyzing the measuring result by the principle component analysis.

(B) Description of the Related Art

Human beings can differentiate four kinds of basic tastes, i.e., sweet, salty, sour and bitter. In the recent years, researchers found that the umami, which is the taste of monosodium glutamate and protein-rich food, is also one of the basic tastes. In other words, human beings have a total of five basic senses of taste. Generally speaking, the taste is a specific nerve signal generated by the different receptors on the taste bud after a certain molecular stimulation, and the combined sense of each receptor is a certain taste. At present, the electronic tongue is designed based on this principle to simulate the sense of the taste.

An electronic tongue is generally equipped with several chemical sensors, which are composed of polymer thin film deposited on a metal electrode electrically connected to a circuit for taste measuring and data analysis. When the electronic tongue contacts a solution under test, the thin film of the sensor can absorb substances dissolved in the solution, and the capacitance (or resistance) of the electrode is therefore changed. By analyzing the combination of capacitance (or resistance) states of each sensor, a specific point may be identified on a diagram for measurement of sweet, salty, sour, bitter and umami tastes.

At present, many researchers have published their research results about electronic taste sensors. For example, (1) the research group under professor Toko in Japan Kyushu University published in 2000 a series of sensing technology including design of taste sensor and analysis of potential measuring, which can be used in the analysis of beers and foods produced from various factories. This research result has been transformed into commercial product (taste detecting system SA402, Anritsu); (2) In 2002, the research group under professors A. Legin and A. Rudnitskaya in St. Petersburg University, Russia published their research result on electronic tongue used in water quality, food, environment and clinical examination analysis; (3) In 2002, professor D. Barrow from British University of Cardiff published his research result on optical electronic tongue used in measuring the water quality in the river; and (4) In 2002-2003, the research group under professor John T. McDevitt from University of Texas at Austin in the United States published their research result on optical electronic tongue used in detecting and analysis of water quality, poison, biochemistry, bacteria, food environment, clinical examination analysis and HPLC detector analysis.

The research of electronic taste sensors primary involves the interface between the electrode of the taste sensor and the electrolyte in the aqueous solution, while the principal component analysis (PCA) is widely used in the subsequent data analysis, both of which are briefly described as follows: [symbol] Interface between the electrode taste sensor and the electrolyte in the aqueous solution:

The structure of a chemical taste sensor electrode is quite simple. It uses the principle that different substances on taste sensors (component combination) will result in different reduction degree of conductivity in the electrolyte aqueous solution. Therefore, if different taste sensors are used to measure the electrical conductivity of an electrolyte aqueous solution, there will be different measurement results.

The discussions of electrode chemical taste sensor are commonly seen in “Electrochemistry” or “Physical Chemistry” textbooks. Generally speaking, electrode-electrolyte aqueous solution will form interface, different electrode will form different interface structure, and the interface will form electrical layer due to unbalanced electric charge. The number of electrical layers is increased and the principle is improved as the development of the research works. For example, the researchers brought up interface electrical layer model for the relation between ion concentration and electrical layer in solution. Since these discussions mainly focus on transfer of electric charge between liquid and liquid, liquid and solid metal, these models are composed of capacitor.

In 1853, Helmholtz considered the interface between the metal and liquid as double electric layers, and also the structure of electrical double layers as being similar to that of a parallel plate capacitor. There is certainly error between the experiment vale and the theoretical value according to this simple model. Therefore, Gouy in 1910 and Champman in 1913 further brought up a modified electrical double layer theory and tried to correct the error between the theoretical value and experimental error according to Helmholtz model. However, the further test demonstrated that each of the two new models has its advantages and cannot completely explain or forecast the experiment vales. Particularly, the two modified models explained the phenomenon of a solution with high and low concentration electrolyte. As for Helmholtz model, the error between the theoretical value and experiment vale is lower when electrolyte solution and the electrode potential is higher. Therefore, Stem and Grahame brought up their modified models in 1924 and 1947, respectively. Up to that time, the errors between the theoretical value and experiment vale were basically within an acceptable range. [symbol] Principal component analysis method:

The principal component analysis method was a statistical method originally brought up by Pearson in 1901, and developed by Hotelling in 1933. Particularly, the principal component analysis method is one of the multivariate analyses. The main objects of the multivariate analysis are: (1) simplification of the data, i.e., simplifying multivariate into a fewer variables; (2) exploratory data analysis, i.e., to explore causality; (3) grouping work of low space diagram such as a bis-space, i.e., to group the related (or similar) individual (or variable) into same group. The user can then explain the phenomenon according to these analysis results. The multivariate analysis is a strong tool to understand and explain the phenomenon. However, it cannot show its effect unless more operation functions are provided. In recent years, the application of multivariate analysis is becoming easier due to the rapid development of personal computer.

US 2004/0009585 Al discloses a taste sensor, which includes an interdigital electrode and a film deposited on the electrode. This film can be made of organic polymer, which has specific chemical affinity to the mixture under test. In addition, U.S. Pat. No. 5,302,262, U.S. Pat. No. 5,482,855 and U.S. Pat. No. 5,789,250 also disclose methods for measuring the potential of the sample under test by artificial lipid film, incorporated with the principal component analysis method in the data analysis to determine the taste of the sample under test.

### SUMMARY OF THE INVENTION

The objective of the present invention is to provide a taste-sensing mixture and a taste sensor and a taste-sensing system using the same, which differentiates different tastes by measuring the conductivity of a solution under test and analyzing the measuring result by the principle component analysis.

In order to achieve the above-mentioned objective and avoid the problems of the prior skills, the present invention provides a taste-sensing mixture and a taste sensor and a taste-sensing system using the same, which differentiates different tastes by measuring the conductivity of a solution under test and analyzing the measuring result by the principle component analysis. The present taste-sensing mixture comprises a carrier and a dispersant dispersed in the carrier. Preferably, the carrier is selected from the group consisting of conductive polymer, salt compound and alkene polymer, while the dispersant is selected from the group consisting of alcohol and gel. The alkene polymer is selected from the group consisting of polyvinyl alcohol, polyethylene oxide, and polystyrene, the alcohol is selected from the group consisting of glycerol, methanol, and ethanol, the conductive polymer can be polypyrrole or polyaniline, the salt compound can be sodium chloride or sodium potassium, and the gel can be agar.

The present taste sensor comprises a tube capable of being dipped in a solution under test, a taste-sensing mixture positioned in the tube and a sensing electrode positioned in the taste-sensing mixture. The tube can be made of semi-permeable membrane, which allows the solution under test to diffuse into the tube and allows the taste-sensing mixture to diffuse into the solution under test. The present taste-sensing system comprises a plurality of taste sensors for measuring the conductivity of a solution under test, a conductivity meter electrically connected to the taste sensors and a data-processing device for deciding the taste of the solution under test by analyzing the conductivity data from the taste sensor.

### BRIEF DESCRIPTION OF THE DRAWINGS

The objectives and advantages of the present invention will become apparent upon reading the following description and upon reference to the accompanying drawings in which:

FIG. 1 illustrates a taste-sensing system according to the present invention;

FIGS. 2-4 show measuring results of conductivity for standard solutions; and

FIGS. 5-8 show two dimensional principle component analysis diagrams.

### DETAILED DESCRIPTION OF THE INVENTION

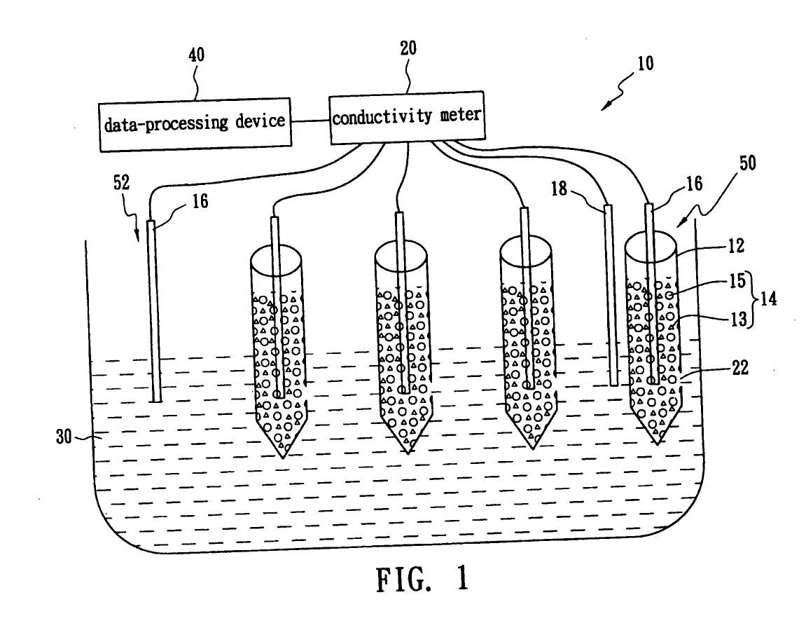

FIG. 1 illustrates a taste-sensing system 10 according to the present invention. The taste-sensing system 10 comprises taste sensors 50 and 52, a conductivity meter 20 electrically connected to the taste sensors and a data-processing device 40 for analyzing the conductivity data from the taste sensors 50 and 52. The taste sensor 50 comprises a tube 12 capable of being dipped in a solution 30 under test, a taste-sensing mixture 14 positioned in the tube 12, and a sensing electrode 16 dipped in the taste-sensing mixture 14. A reference electrode 18 is dipped in the solution 30 under test. The taste-sensing electrode 52 is made of the sensing electrode 16 only, and the sensing electrode 16 of the taste sensor 52 is dipped in the solution 30 under test directly. Particularly, the taste-sensing system 10 further comprises a reference electrode 18, and both of the taste sensors 50 and 52 commonly use the reference electrode 18.

The tube 12, made of semi-permeable film, allows the solution 30 under test to diffuse into the internal part of the tube 12, and allows the taste-sensing mixture 14 to diffuse into the solution 30 under test. In addition, the tube 12 can also be made of other impermeable materials and has a tiny opening 22 as a diffusing channel. It is preferable that the sensing electrode 16 and the reference electrode 18 are made of conductive metal such as silver.

The taste-sensing mixture 14 comprises a carrier 15 and a dispersant 13 dispersed in the carrier 15. Preferably, the carrier 15 is selected from the group consisting of conductive polymer, salt compound and alkene polymer, while the dispersant 13 is selected from the group consisting of alcohol and gel. The preferable recipes of the taste-sensing mixture 14 are shown in the following table:

| Recipe number | Composition | Weight ratio |
|---|---|---|
| 1 | alkene polymer + gel | 1:1 to 10:1 |
| 2 | alkene polymer + alcohol | 1:1 to 10:1 |
| 3 | conductive polymer + gel | 1:1 to 10:1 |
| 4 | salt solution + gel | 1:1 to 10:1 |

Preferably, the alkene polymer is selected from the group consisting of polyvinyl alcohol (PVA), polyethylene oxide (PEO) and polystyrene (PS), the alcohol is selected from the group consisting of glycerol, methanol and ethanol, conductive polymer is selected from the group consisting of polypyrrole or polyaniline, the salt solution may be sodium chloride solution or potassium chloride solution, and the gel can be agar.

[symbol]

Experiment

First, five taste sensors are prepared according to the composition of the taste-sensing mixture 14 shown in the following table:

| Sensor number | Composition |
|---|---|
| 1 | Polyvinyl alcohol (12 g) + agar (1.8 g) |
| 2 | Polyvinyl alcohol (12 g) + glycerin (1.6 cc) |
| 3 | Polypyrrole + agar |
| 4 | Potassium chloride solution + agar |
| 5 | None |

Referring to FIG. 1, the sensing electrode 16 and the reference electrode 18 of the five taste sensors are all made of silver. Particularly, the sensing electrode 16 of the taste sensors 1-4 was positioned in the taste-sensing mixture 14, and the tube 12 containing the taste-sensing mixture 14 and the sensing electrode 16 is then dipped into the solution 30 under test. As to the taste sensor 5, i.e., the taste sensor 52, the sensing electrode 16 is directly dipped into the solution 30 under test. It is foreseeable that the conductivity measured by the taste sensor 5 (i.e. silver-silver taste sensor 52) will be higher than those measured by the taste sensors 1-4 since the taste sensor 5 is made of conductive metal only and the measured conductivity certainly will be the highest.

Five different standard solutions with different tastes and different concentrations are prepared according to the present invention, and the conductivity meter 20 is used to verify the relation between the conductivity and the concentration of the standard solution. The concentration and category of the standard solution together with the measured conductivity are shown in the following table:

| | | | |
|---|---|---|---|
| Category and | Conductivity | Category and | Conductivity |
| concentration | (μS) | concentration | (μS) |

| | |
|---|---|
| Sucrose | Quinine |

| | | | | | |
|---|---|---|---|---|---|
| 100 | mg/dl | 1.4 | 0.03 | mM | 5.4 |
| 200 | mg/dl | 1.5 | 0.1 | mM | 20.7 |
| 300 | mg/dl | 1.7 | 0.3 | mM | 23.6 |
| 400 | mg/dl | 2.4 | 1 | mM | 32 |
| 500 | mg/dl | 5.7 | 3 | mM | 47.6 |

| | |
|---|---|
| Glucose | NaCl |

| | | | | | |
|---|---|---|---|---|---|
| 100 | mg/dl | 2.7 | 0.03 | mM | 8.5 |
| 200 | mg/dl | 2.9 | 0.3 | mM | 56.5 |
| 300 | mg/dl | 6.5 | 3 | mM | 347 |
| 400 | mg/dl | 3.2 | 30 | mM | 3550 |
| 500 | mg/dl | 21.8 | 300 | mM | |

| | |
|---|---|
| Umami | Sour |

| | | | | |
|---|---|---|---|---|
| 0.03 | mM | 21.4 | PH 1.68 | 1318 |
| 0.3 | mM | 41.6 | PH 4.01 | 4280 |
| 3 | mM | 213 | PH 7 | 5500 |
| 30 | mM | 1815 | PH 9.18 | 1512 |
| 300 | mM | 11930 | PH 10.01 | 5880 |

General speaking, the concentration is proportional to the conductivity, i.e. the higher the concentration, the higher the conductivity. From the above table, one can see that different categories and different tastes possess different conductivity distributions. Since the dissociation of NaCl is higher, the conductivity of NaCl under the same concentration is higher than those of other standard solutions. The quinine and sweet taste, such as sucrose and glucose, possess smaller conductivity, umami taste possesses a similar conductivity as NaCl, and sour possesses a unique conductivity distribution. Since there is a certain difference between the conductivity distributions of different tastes, the conductivity distribution may be used as an index for the taste measurement.

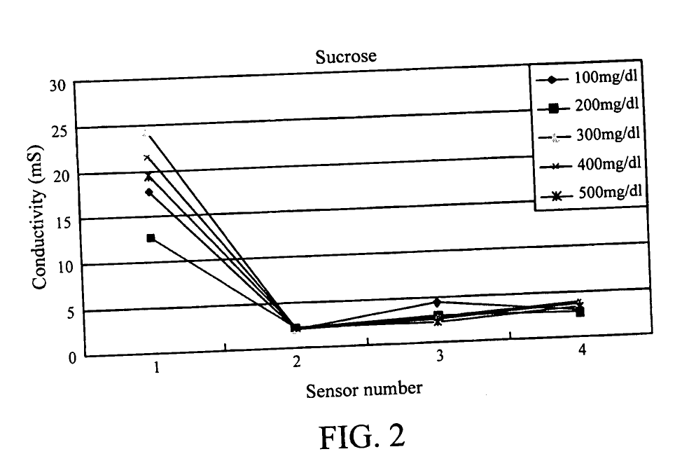

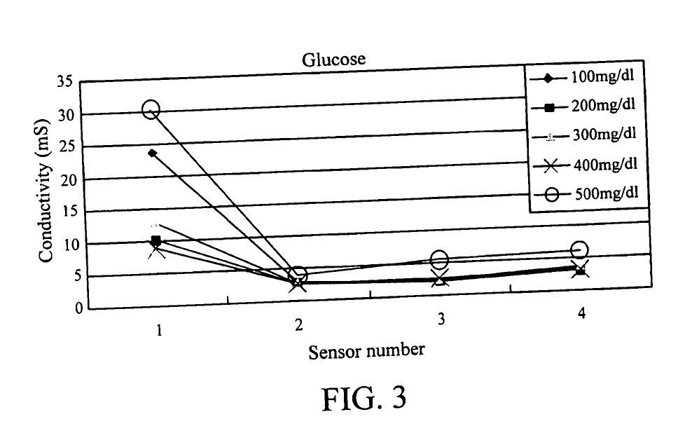

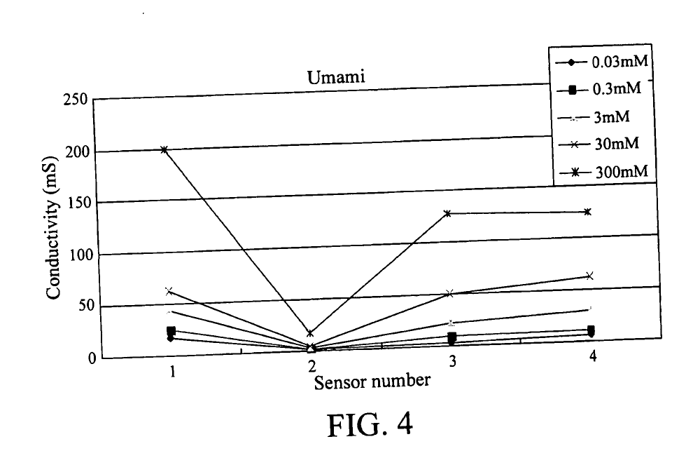

FIGS. 2-4 show measuring results for standard solutions. The output of the five taste sensors 50 and 52 is connected to the input terminal of conductivity meter 20 to measure the conductivity of the standard solution. FIGS. 2-4 only show the measuring result of taste sensors 1-4, i.e., the taste sensors 50 having the taste-sensing mixture 14 in the tube 12. FIG. 2 shows the measured conductivity of sucrose, FIG. 3 shows the measured conductivity of glucose, and FIG. 4 shown the measured conductivity of umami.

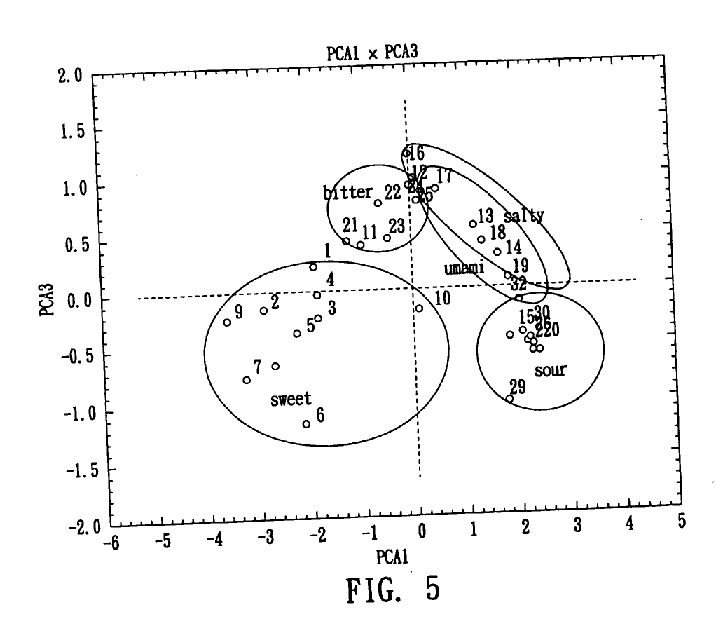

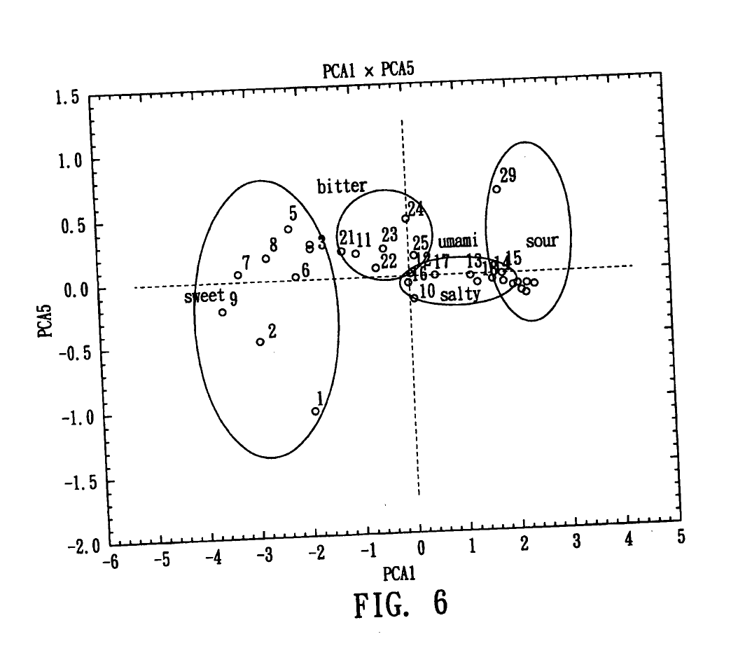

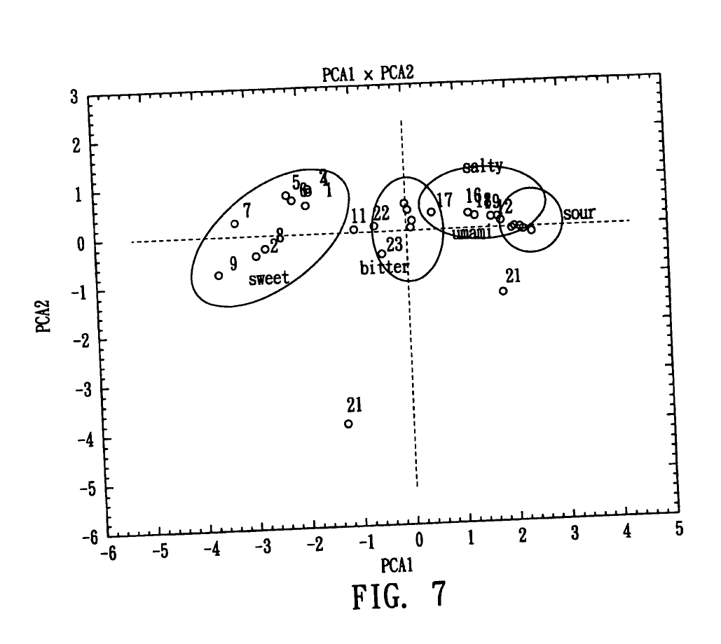

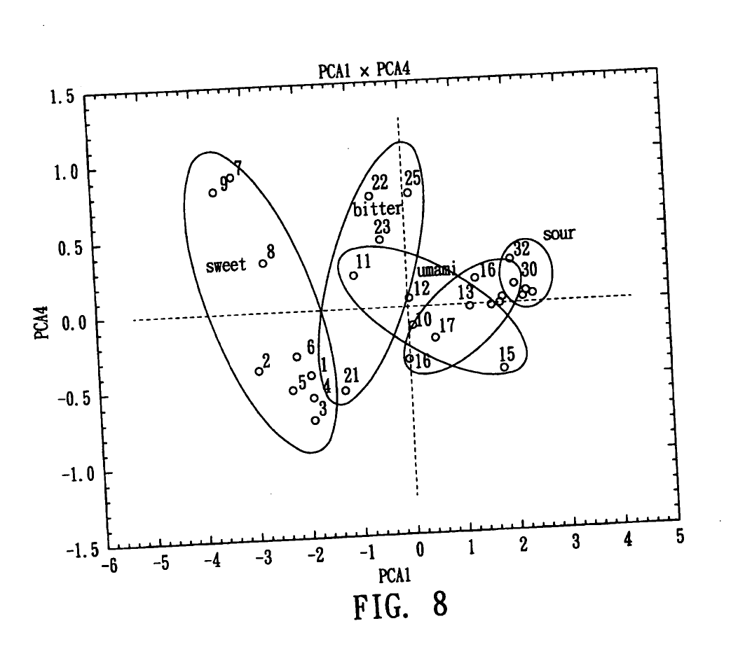

FIGS. 5-8 show two dimensional principle component analysis diagrams. FIG. 5 is the two dimensional principle component analysis diagram of PCA1 to PCA3. FIG. 6 is the two dimensional principle component analysis diagram of PCA1 to PCA5. FIG. 7 is the two dimensional principle component analysis diagram of PCA1 to PCA2. FIG. 8 is the two dimensional principle component analysis diagram of PCA1 to PCA4.

Referring to FIG. 5, sweet taste (sucrose and glucose) is obviously at lower left, bitter is at upper left, sour is at lower right, and salty and Umami tastes are at upper right. Except that the salty and umami tastes cannot be effectively differentiated from each other, the other three tastes can be differentiated from FIG. 5.

In a similar way, FIGS. 6 and 8 have substantially the same differentiating capability except there is a little difference in distribution region and shape. The reason why FIGS. 6 and 8 have the same differentiating capability is that all of these principle component analysis diagrams contain PCA1. That is to say, so long as a principle component analysis diagram contains PCA1, it can be used to differentiate tastes effectively. Particularly, the differentiating capacity of FIG. 7 is the best since different tastes respectively occupy 4 quadrants.

The above-described embodiments of the present invention are intended to be illustrative only. Numerous alternative embodiments may be devised by those skilled in the art without departing from the scope of the following claims.

1. A taste-sensing mixture for use in taste sensing of a liquid sample, comprising:
a carrier including a salt compound; and
a dispersant including glycerol dispersed in the carrier.

2-3. (canceled)

4. The taste-sensing mixture of claim 1, wherein the salt compound is sodium chloride or sodium potassium.

5. A taste sensing mixture for use in taste sensing of a liquid sample, comprising:
a carrier including polyethylene oxide; and
a dispersant including glycerol dispersed in the carrier.

6. The taste sensing mixture of claim 5, wherein the weight ratio of the carrier to the dispersant is between 1:1 and 10:1.

7. The taste-sensing mixture of claim 1, wherein the weight ratio of the carrier to the dispersant is between 1:1 and 10:1.

8-28. (canceled)
